(19) United States
(12) Patent Application Publication
(10) Pub. No.: US 2026/0170761 A1
(43) Pub. Date: Jun. 18, 2026

(54) DEEP LEARNING-BASED 2D GAUSSIAN ESTIMATION METHOD AND APPARATUS THEREOF

(71) Applicant: KOREA UNIVERSITY RESEARCH AND BUSINESS FOUNDATION, Seoul (KR)

(72) Inventors: Jung Hyun HAN, Seoul (KR); Myoung Gon KIM, Suwon-si (KR)

(21) Appl. No.: 19/412,683

(22) Filed: Dec. 8, 2025

(30) Foreign Application Priority Data
Dec. 13, 2024 (KR) 10-2024-0186375
Apr. 7, 2025 (KR) 10-2025-0044717

(51) Int. Cl. G06T 17/20; G06V 10/77

(52) U.S. Cl. CPC G06T 17/20; G06V 10/7715

(57) ABSTRACT

The deep learning-based 2D Gaussian estimation method may include: (a) randomly generating a Voronoi diagram and partitioning each region of the Voronoi diagram into a respective polygon; (b) generating a gradient map, a center probability map, and a covariance map based on each of the partitioned polygons and configuring a dataset using the gradient map, the center probability map, and the covariance map; (c) training a deep learning-based Gaussian estimation model using the dataset so that the deep learning-based Gaussian estimation model generates a center probability map and a covariance map for an input image; and (d) inputting an image to the trained deep learning-based Gaussian estimation model to generate a center probability map and a covariance map, and post-processing the center probability map and the covariance map to derive 2D Gaussian parameters including a mean and a covariance.

### CROSS-REFERENCE TO RELATED APPLICATION

This application claims the benefit of priority under 35 U.S.C. § 119(a) to Korean Patent Application No. 10-2024-0186375 filed on Dec. 13, 2024, and Korean Patent Application No. 10-2025-0044717 filed on Apr. 7, 2025, the entire contents of which is incorporated herein by reference.

### BACKGROUND

### (a) Technical Field

The present disclosure relates to a deep learning-based 2D Gaussian estimation method and apparatus thereof.

### (b) Background Art

Conventionally, in order to detect specific patterns or regions in an image, traditional image processing algorithms (e.g., Canny edge detection, Hough transform) or local feature-based keypoint detection techniques (such as SIFT and SURF) have mainly been used. These algorithms are effective in detecting feature points in an image and utilizing them to identify specific patterns or structures. However, such conventional methods are not suitable for directly extracting a mathematical representation of an image (e.g., a Gaussian distribution), and require complex post-processing.

Recently, techniques for learning high-dimensional information of images using deep learning have attracted attention. In particular, CNN-based models have shown outstanding performance in object detection and segmentation; however, these techniques are mainly focused on classification and bounding-box extraction, and therefore are difficult to apply to extraction of a mathematical representation of an image, such as a Gaussian distribution.

As prior art, there exist spatial partitioning methods using Voronoi diagrams and techniques for predicting object centers using a gradient map and a center map. However, there is no technique that directly extracts 2D Gaussians by combining such methods with deep learning.

### SUMMARY OF THE DISCLOSURE

The present disclosure is directed to providing a deep learning-based 2D Gaussian estimation method and apparatus thereof.

In addition, the present invention is directed to providing a deep learning-based 2D Gaussian estimation method and an apparatus thereof, which are capable of estimating 2D Gaussians having an appropriate distribution according to the complexity of a given image by training a model using a Voronoi diagram. That is, in a complex region (a region having a high frequency) of an image, a large number of 2D Gaussians can be estimated, whereas in a simple region (a region having a low frequency), a small number of 2D Gaussians can be estimated.

Furthermore, the present invention is directed to providing a deep learning-based 2D Gaussian estimation method and an apparatus thereof, in which 2D Gaussians estimated by the model can be used as initial values of 3D Gaussians, thereby shortening a development and deployment process of a 3DGS (3D Gaussian Splatting)-based system, improving computational efficiency, and enhancing three-dimensional rendering quality.

In addition, the present invention is directed to providing a deep learning-based 2D Gaussian estimation method and an apparatus thereof, which can offer data processing and representation efficiency by mathematically expressing high-dimensional data in a concise form, and which are applicable to various applications such as computer vision, medical image analysis, and robot vision.

According to one aspect of the present disclosure, a deep learning-based 2D Gaussian estimation method is provided.

According to an embodiment of the present disclosure, the deep learning-based 2D Gaussian estimation method, may comprise: (a) randomly generating a Voronoi diagram and partitioning each region of the Voronoi diagram into a respective polygon; (b) configuring a dataset by generating a gradient map, a center probability map, and a covariance map based on each of the partitioned polygons; (c) training a deep learning-based Gaussian estimation model using the dataset so that the deep learning-based Gaussian estimation model is configured to output, for an input image, corresponding center probability and covariance maps; and (d) inputting an image to the trained deep learning-based Gaussian estimation model to generate a center probability map and a covariance map, and deriving 2D Gaussian parameters including a mean and a covariance by post-processing the target center probability map and the target covariance map.

In step (a), the method may comprise: (a1) randomly generating seed points and generating a Voronoi diagram based on the seed points; and (a2) randomly assigning colors to the respective regions of the Voronoi diagram.

A number of seed points, a number of colors, and a distribution of polygons may be randomly determined.

Generating the covariance map of the dataset may comprise: (b1) designating, as a center point, a target interior pixel of each polygon; (b2) calculating a variance and a covariance by using the center point and coordinate values of boundary pixels of the polygon including the target interior pixel; and (b3) generating a covariance matrix for the target interior pixel by using the calculated variance and covariance, wherein steps (b1) to (b3) are repeatedly performed for all interior pixels of each polygon so as to generate the covariance map.

The covariance map may be expressed as any one of: a first covariance map having a size of 2×2×H×W and including all elements of a 2×2 covariance matrix; a second covariance map having a size of 3×H×W and obtained by reducing the 2×2 covariance matrix so as to include only three distinct elements of the 2×2 covariance matrix; and a third covariance map having a size of 3×H×W and comprising components {a, b, c} of a lower triangular matrix obtained by applying Cholesky factorization to a 2×2 covariance matrix corresponding to each pixel constituting the covariance map so as to decompose the 2×2 covariance matrix into a product of the lower triangular matrix and a transpose matrix of the lower triangular matrix.

The deep learning-based Gaussian estimation model may comprise: an encoder configured to receive the image and extract a feature map; a first decoder configured to reconstruct the feature map to generate a gradient map; a weight feature map generation module configured to generate a gradient weight feature map by scaling the gradient map to a size identical to that of the feature map and performing element-wise multiplication; a second decoder configured to receive the gradient weight feature map and generate a center probability map; and a third decoder configured to receive the gradient weight feature map and generate a covariance map.

According to another aspect of the present disclosure, an apparatus for performing the deep learning-based 2D Gaussian estimation method is provided.

According to an embodiment of the present disclosure, a computing device may be provided, the computing device comprising: a dataset construction unit configured to randomly generate a Voronoi diagram and construct a dataset utilizing the Voronoi diagram; a training unit configured to train a deep learning-based Gaussian estimation model to generate a Center Probability Map and a Covariance Map for an input image using the dataset; and a Gaussian estimation unit configured to input an image into the trained deep learning-based Gaussian estimation model to generate a Center Probability Map and a Covariance Map, and obtain 2D Gaussian parameters including a mean and a covariance by post-processing the Center Probability Map and the Covariance Map.

### BRIEF DESCRIPTION OF DRAWINGS

FIG. 1 is a flowchart illustrating a deep learning-based adaptive Gaussian estimation method according to an embodiment of the present disclosure.

FIGS. 2 to 4 are diagrams illustrating examples of a Voronoi diagram for an input image according to an embodiment of the present disclosure.

FIG. 5 is a diagram illustrating a Gradient Map generated utilizing a Voronoi diagram according to an embodiment of the present disclosure.

FIG. 6 is a diagram illustrating a Center Probability Map and a Covariance Map generated utilizing a Voronoi diagram according to an embodiment of the present disclosure.

FIGS. 7 and 8 are diagrams illustrating a method of generating a Covariance Map according to an embodiment of the present disclosure.

FIGS. 9 and 10 are diagrams illustrating the architecture of a deep learning-based Gaussian estimation model according to an embodiment of the present disclosure.

FIGS. 11 and 12 are exemplary diagrams visualizing 2D Gaussians according to an embodiment of the present disclosure.

FIG. 13 is a diagram illustrating a process of generating a 2D Gaussian according to an embodiment of the present disclosure.

FIG. 14 is a diagram illustrating a process of converting a 2D Gaussian into a 3D Gaussian according to an embodiment of the present disclosure.

FIG. 15 is a block diagram schematically illustrating the internal configuration of a computing device according to an embodiment of the present disclosure.

FIG. 16 is a diagram illustrating an example of extracting a 2D Gaussian for a general image according to an embodiment of the present disclosure.

### DETAILED DESCRIPTION

Singular forms used in this specification include plural forms unless the context clearly indicates otherwise. In the specification, the term “configured”, “include”, or the like should not be construed as necessarily including several components or several steps described herein, in which some of the components or steps may not be included or additional components or steps may be further included. Further, the terms “˜unit”, “module”, and the like mean a unit for processing at least one function or operation and may be implemented by hardware or software or by a combination of hardware and software.

Hereinafter, the embodiments of the present disclosure will be described in detail with reference to the accompanying drawings.

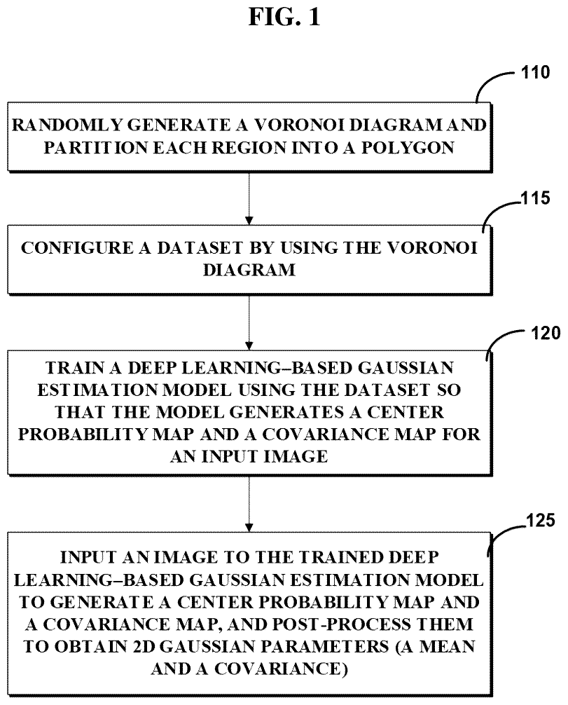

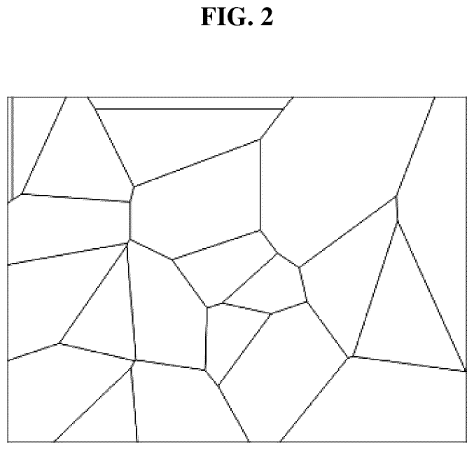

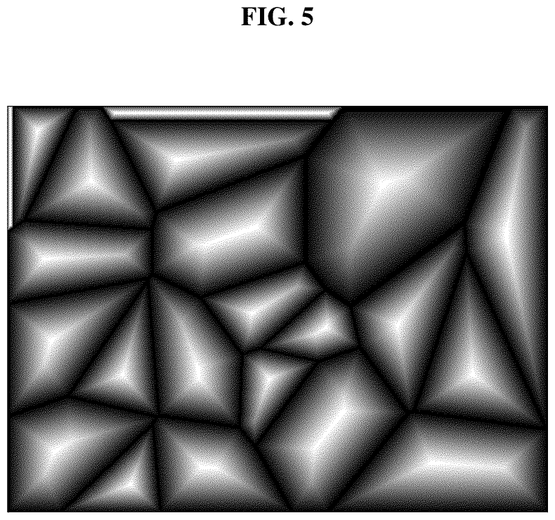

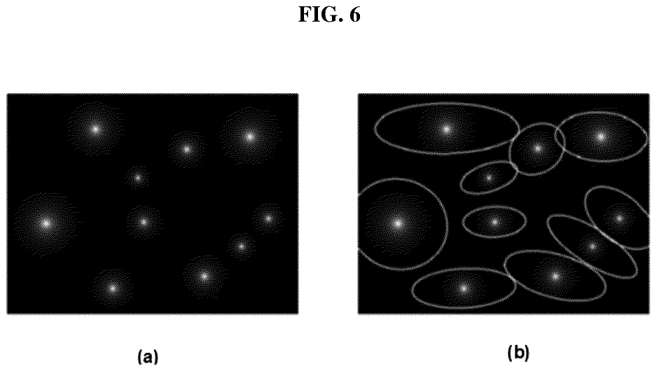

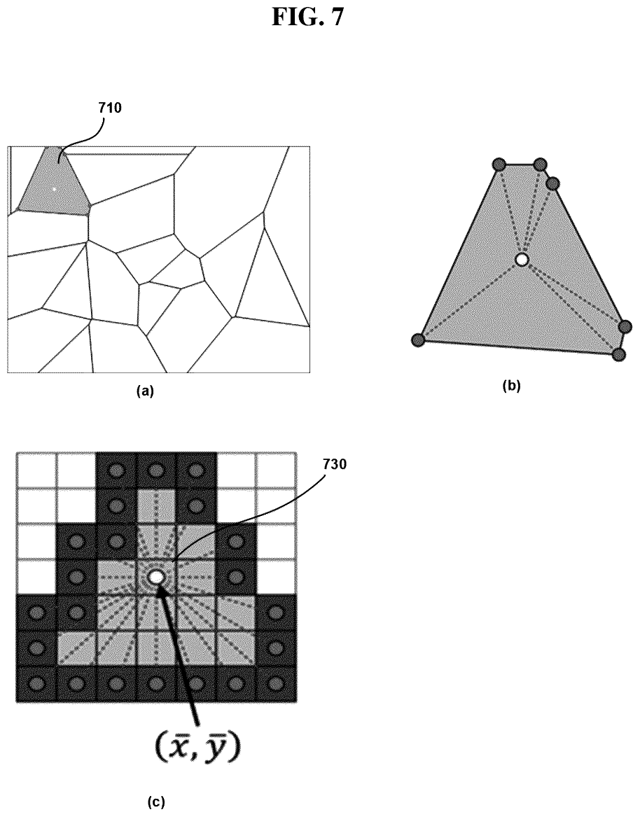

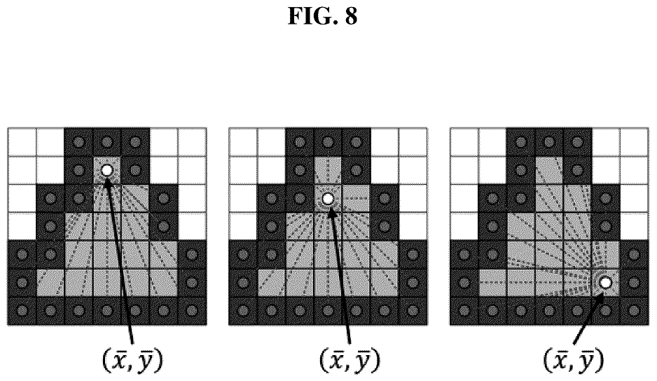

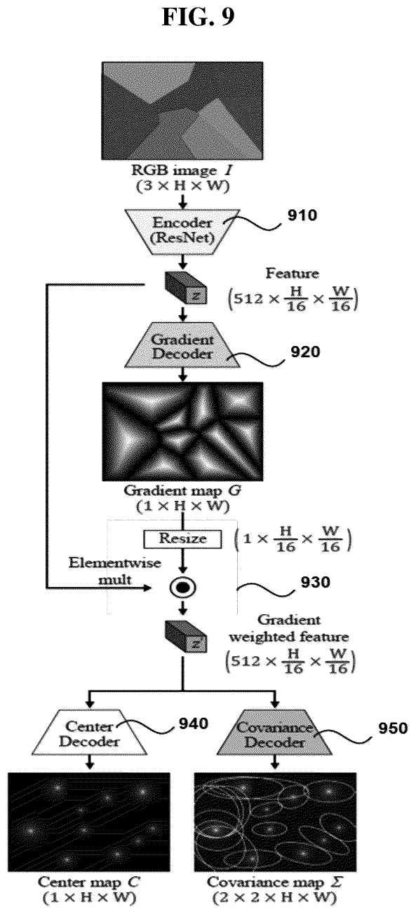

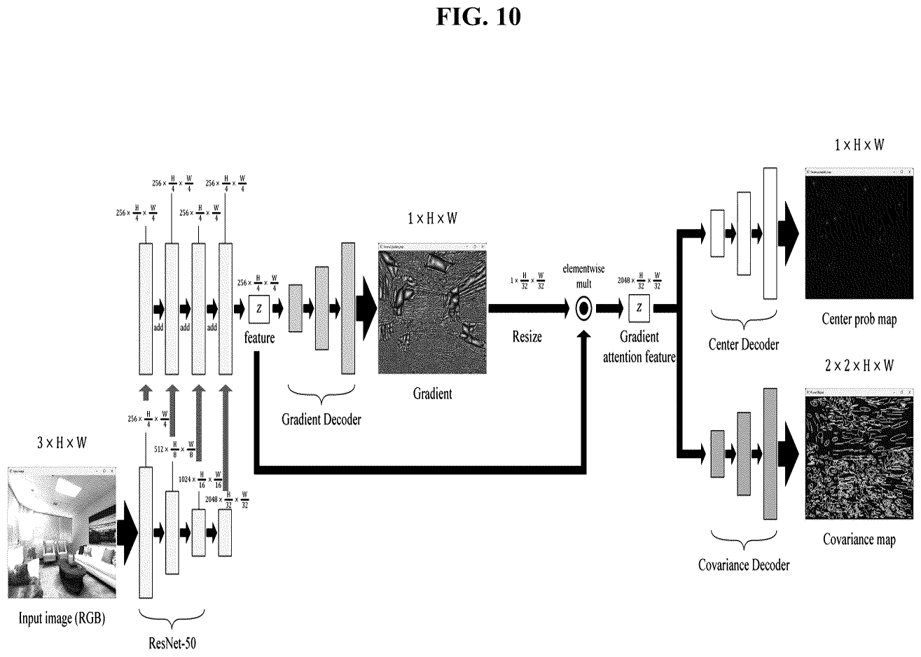

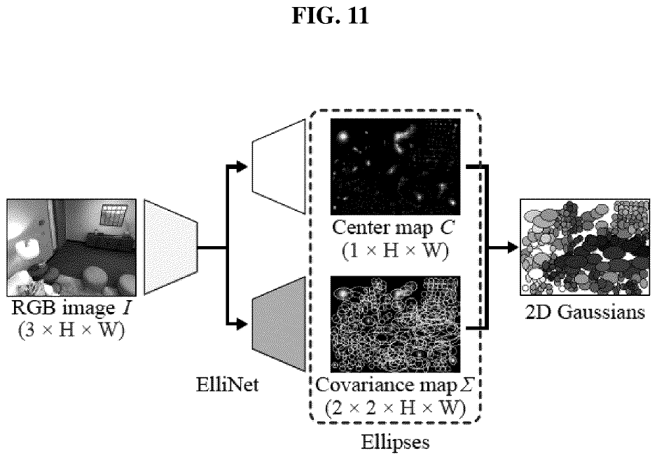

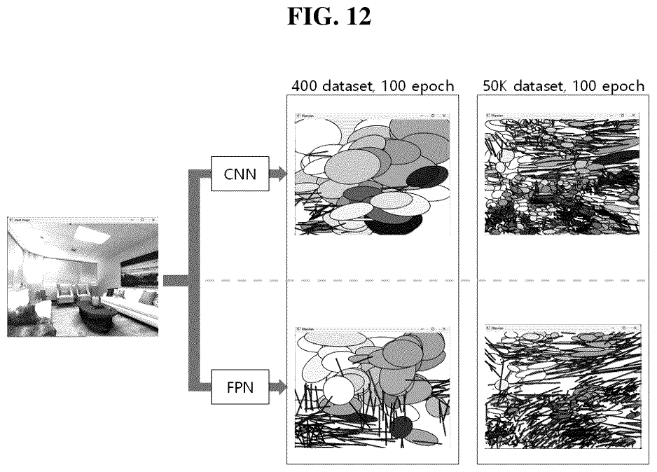

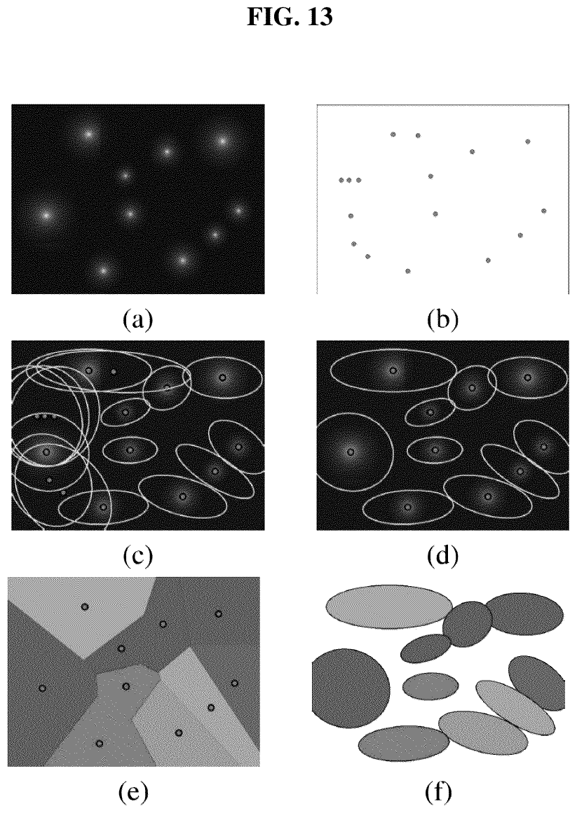

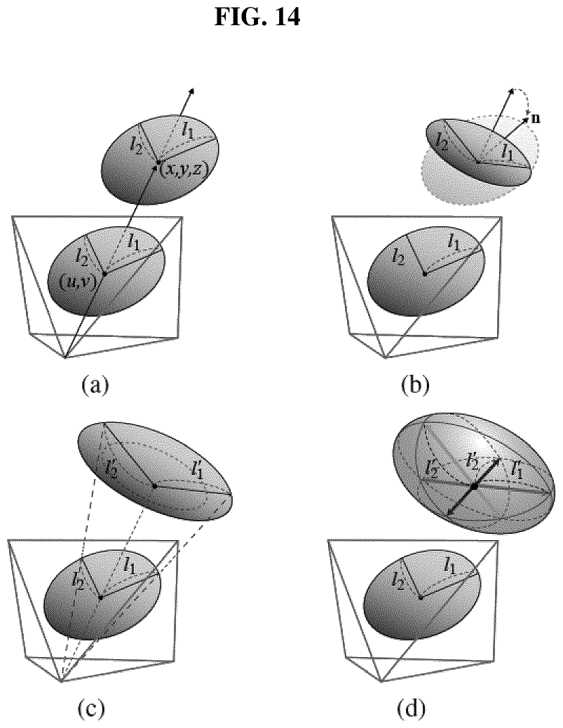

FIG. 1 is a flowchart illustrating a deep learning-based adaptive Gaussian estimation method according to an embodiment of the present disclosure, FIGS. 2 to 4 are diagrams illustrating examples of a Voronoi diagram for an input image according to an embodiment of the present disclosure, FIG. 5 is a diagram illustrating a Gradient Map generated utilizing a Voronoi diagram according to an embodiment of the present disclosure, FIG. 6 is a diagram illustrating a Center Probability Map and a Covariance Map generated utilizing a Voronoi diagram according to an embodiment of the present disclosure, FIGS. 7 and 8 are diagrams illustrating a method of generating a Covariance Map according to an embodiment of the present disclosure, FIGS. 9 and 10 are diagrams illustrating the architecture of a deep learning-based Gaussian estimation model according to an embodiment of the present disclosure, FIGS. 11 and 12 are exemplary diagrams visualizing 2D Gaussians according to an embodiment of the present disclosure, FIG. 13 is a diagram illustrating a process of generating a 2D Gaussian according to an embodiment of the present disclosure, and FIG. 14 is a diagram illustrating a process of converting a 2D Gaussian into a 3D Gaussian according to an embodiment of the present disclosure.

In step 110, a computing device 100 randomly generates a Voronoi diagram and partitions each region into a respective polygon.

This will be described in more detail below.

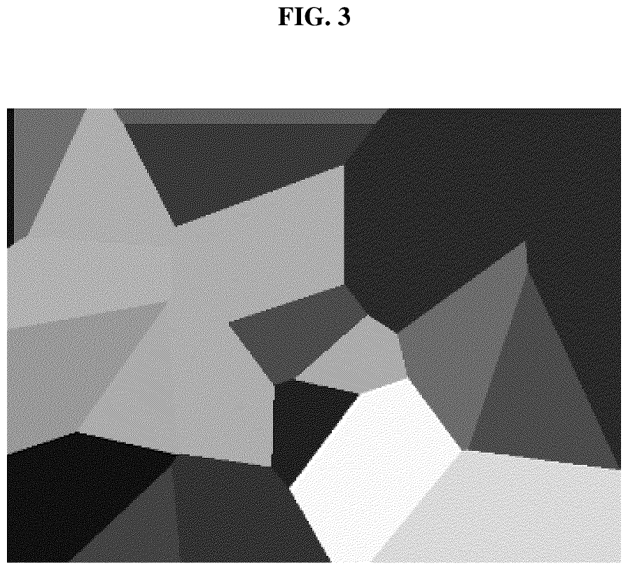

FIGS. 2 and 3 illustrate an example of a Voronoi diagram.

The computing device 100 may generate a plurality of seed points and then partition each region into a respective polygon (see FIG. 2). As shown in FIG. 2, the Voronoi diagram partitions a plane into regions each consisting of a set of points closest to a corresponding seed point, and each partitioned region may be formed as a convex polygon.

Accordingly, the computing device 100 may randomly generate seed points. A number of the seed points may be randomly generated in a range of 10 to 500.

Subsequently, as illustrated in FIG. 3, the computing device 100 may assign a respective color to each polygon.

The computing device 100 may randomly determine a number of colors. For example, the computing device 100 may randomly generate 10 to 100 colors, and randomly assign and fill the partitioned polygonal regions with colors within the generated color range. In this case, a number of color clusters may be randomly set to be in a range of 1 to 10.

In this manner, by preliminarily generating a predetermined number of colors and then assigning selected colors to the polygonal regions such that adjacent regions are assigned the same color, cases in which the regions appear as concave shapes in the input image can be generated.

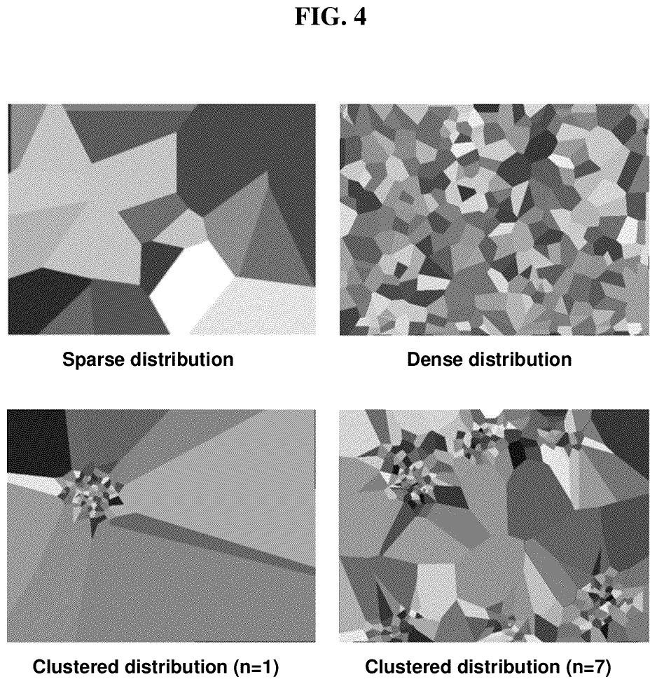

In addition, as illustrated in FIG. 4, a distribution of polygons may also be randomly determined. As shown in FIG. 4, the computing device 100 may generate the Voronoi diagram with various distributions.

In summary, the computing device 100 may randomly generate the Voronoi diagram by randomly adjusting (determining) a number of seed points, a number of colors, and a polygon distribution.

In step 115, the computing device 100 configures a dataset by using the Voronoi diagram.

This will be described in more detail below.

The computing device 100 may generate a gradient map and a center probability map based on each of the partitioned polygons.

For example, the computing device 100 may generate the gradient map on the basis of boundary lines of each polygon (see FIG. 5). In addition, the computing device 100 may generate the center probability map by using a centroid of each polygon (see FIG. 6). As illustrated in FIG. 6(a), the center probability map is a probability map that encodes, for each pixel, a likelihood that the pixel is a center of a polygon. For each pixel within a polygon, a Euclidean distance to the center is normalized by a minimum edge distance, and is adjusted by a fast decaying function. This can be expressed mathematically as in Equation 1.

$$f ( d ) = \frac{1}{1 + 10 d} \qquad [ Equation 1 ]$$

Here, d denotes a normalized distance to a centroid.

In addition, the computing device 100 may generate a covariance map using centroid information of each polygon. A result of visualizing sampled center regions of Gaussians from the covariance map is illustrated in FIG. 6(b).

For ease of understanding and explanation, a description will now be given with reference to FIG. 7.

As shown in FIG. 7(a), a target polygon 710 has six vertices, and when approximated, it may be represented as shown in FIG. 7(b). It is assumed that further approximating FIG. 7(b) yields FIG. 7(c). With reference to FIG. 7(c), the computing device 100 may set each interior pixel of the polygon as a center point (mean value).

For convenience of description, such an interior pixel will be referred to as a target interior pixel 730. The target interior pixel 730 may be set as the center point (mean value). Subsequently, the computing device 100 may calculate a variance and a covariance by using the center point 730 and coordinate values of boundary pixels.

That is, the computing device 100 may calculate a variance of the target interior pixel 730 as in Equation 2, and may calculate a covariance as in Equation 3.

$$Var ( x ) = \frac{1}{n} {\sum }_{i = 1}^{n} {( {x}_{i} - \overline{x} )}^{2} \qquad [ Equation 2 ]$$

$$Var ( y ) = \frac{1}{n} {\sum }_{i = 1}^{n} {( {y}_{i} - \overline{y} )}^{2}$$

$$Cov ( x , y ) = \frac{1}{n} {\sum }_{i = 1}^{n} ( {x}_{i} - \overline{x} ) ( {y}_{i} - \overline{y} ) \qquad [ Equation 3 ]$$

In Equation 2 and Equation 3, i denotes an index of the boundary pixels, xᵢ denotes an x-coordinate value of the boundary pixels, and x̅ denotes an x-coordinate value of the center point. In addition, yᵢ denotes a y-coordinate value of the boundary pixels, and y̅ denotes a y-coordinate value of the center point.

In this manner, when the variance and covariance are respectively calculated by using the coordinates of the center point and the boundary pixels, the computing device 100 may generate a 2×2 covariance matrix for the target interior pixel 730. By repeating this process, 2×2 covariance matrices may be generated for all pixels inside the polygon (see FIG. 8).

The 2×2 covariance matrix may be expressed as in Equation (4).

$$σ = [ \begin{matrix}Var ( x ) & Cov ( x , y ) \\ Cov ( x , y ) & Var ( y )\end{matrix} ] \qquad [ Equation 4 ]$$

By repeatedly performing the above process, a four-dimensional covariance map of size 2×2×H×W may be generated.

As can be seen from Equation 4, since the covariance matrix is a 2×2 symmetric matrix, the off-diagonal elements Cov(x, y) and Cov(x, y) are identical. Accordingly, although a four-dimensional covariance map of size 2×2×H×W is generated, by using this symmetry only three entries have mutually different values, and thus the covariance map can practically be represented as a three-dimensional covariance map of size 3×H×W.

In order to generate the covariance map, a 2×2 covariance matrix has to be calculated for all pixels, including interior pixels and boundary pixels of the polygon. Accordingly, the computing device 100 may set each pixel as a center point coordinates ((x̅, y̅)), and may compute a covariance matrix by using center coordinates

$${\{ {x}_{i} , {y}_{i} \}}_{i = 1}^{N}$$

of boundary pixels constituting σ a boundary of the polygon.

The computing device 100 may configure a gradient map, a center probability map, and a covariance map for an input image as a dataset.

According to an embodiment of the present invention, the computing device 100 may apply Cholesky factorization to the covariance map. Accordingly, a Cholesky-factorized covariance map can be represented as in Equation 5.

$$σ = {LL}^{T} , L = [ \begin{matrix}a & 0 \\ b & c\end{matrix} ] \qquad [ Equation 5 ]$$

The computing device 100 may apply Cholesky factorization to a covariance matrix to decompose a 2×2 covariance matrix corresponding to each pixel of the covariance map into a product of a lower triangular matrix and a transpose matrix of the lower triangular matrix, thereby representing a covariance for each pixel with three parameters {a, b, c}.

In step 120, the computing device 100 may train a deep learning-based Gaussian estimation model using the dataset so that the deep learning-based Gaussian estimation model generates a center probability map and a covariance map for an input image.

An overall architecture of the deep learning-based Gaussian estimation model is illustrated in FIGS. 9 and 10.

The deep learning-based Gaussian estimation model includes an encoder 910, a first decoder 920, a weighted feature map generation module 930, a second decoder 940, and a third decoder 950.

The encoder 910 is a means for receiving an input image and extracting a feature map. The encoder 910 may be a neural-network-based model or a feature pyramid network-based model.

For example, the encoder 910 may be a model based on ResNet-50.

The first decoder 920 is a means for reconstructing the feature map extracted by the encoder 910 and generating a gradient map. The gradient map serves as an auxiliary output and plays a role in enhancing feature representation through weighting before predicting final outputs, namely a center probability map and a covariance map. Accordingly, the gradient map may be included in the dataset.

The first decoder 920 may be trained so that a difference between the generated gradient map and a gradient map included in the dataset is minimized.

The weighted feature map generation module 930 may scale the gradient map to have the same size as the feature map, and may generate a gradient-weighted feature map by performing element-wise multiplication on the scaled gradient map and the feature map.

The gradient-weighted feature map is respectively input to the second decoder 940 and the third decoder 950. The second decoder 940 may predict a center probability map by using the gradient-weighted feature map, and the third decoder 950 may predict a covariance map by using the gradient-weighted feature map.

The second decoder 940 and the third decoder 950 may also be trained by using the center probability map and the covariance map included in the dataset.

In this manner, the computing device 100 may train the deep learning-based Gaussian estimation model so that the deep learning-based Gaussian estimation model generates a center probability map and a covariance map for an input image.

The deep learning-based Gaussian estimation model may be trained by using a mean squared error (MSE) that minimizes differences between the center probability map and the covariance map included in the dataset and a center probability map and a covariance map output by the deep learning-based Gaussian estimation model.

Assume that Cᵢⱼ, Σᵢⱼ, and Gᵢⱼ denote datasets representing a center probability map, a covariance map, and a gradient map at a pixel (i, j), respectively, and that Ĉᵢⱼ, \hat{Σ}ᵢⱼ, and Ĝᵢⱼ denote a center probability map, a covariance map, and a gradient map predicted by the deep learning-based Gaussian estimation model. In the spatial dimension H×W, three loss functions can be expressed as in Equation 6.

$${C}_{} = \frac{1}{HW} {\sum }_{i , j} {( {\hat{C}}_{ij} - {C}_{ij} )}^{2} \qquad [ Equation 6 ]$$

$${\sum }_{} = \frac{1}{HW} {\sum }_{i , j} {( {\hat{\sum }}_{ij} - {\sum }_{ij} )}^{2}$$

$${G}_{} = \frac{1}{HW} {\sum }_{i , j} {( {\hat{G}}_{ij} - {G}_{ij} )}^{2}$$

A final loss function may be calculated as in Equation 7 by applying an edge-aware technique utilizing the gradient map while balancing center prediction and covariance prediction.

$$= {λ}_{C} {C}_{} + {λ}_{\sum } {\sum }_{} + {λ}_{G} {G}_{} \qquad [ Equation 7 ]$$

Here, λ_{C}, λ_{Σ} and λ_{G} denote each weight. After completion of training, in step 125, the computing device 100 may input an input image to the trained deep learning-based Gaussian estimation model to generate a center probability map and a covariance map, and may post-process the center probability map and the covariance map to obtain 2D Gaussian parameters (a mean and a covariance). FIGS. 11 and 12 illustrate an example of visualizing 2D Gaussians. A 3D Gaussian may be generated by using such 2D Gaussians. This will be described in more detail below.

First, the computing device 100 extracts local maxima from the predicted center probability map. FIG. 13(a) shows the predicted center probability map, and dots in FIG. 13(b) indicate the local maxima.

The computing device 100 samples the predicted covariance map to extract a covariance at each local maximum. This is illustrated in FIG. 13(c). At this time, overlapping ellipses may exist, and unnecessary ellipses may be removed based on criteria such as overlap, size, and reliability. For example, when ellipses extracted at the local maxima substantially overlap one another, only the ellipse having the highest reliability (i.e., the highest center probability) may be left and the others may be removed. In addition, similarity between covariance matrices may be compared so that only one ellipse among similar ellipses is retained, an ellipse having a size that is too small may be regarded as noise and removed, and an ellipse having a size that is too large may be restricted because it may excessively represent a single object. Furthermore, when a probability value in the center probability map is less than a predetermined threshold, a corresponding ellipse may be removed, and singular values of a predicted covariance matrix may be analyzed so that an ellipse having low reliability is filtered out. A result of removing unnecessary ellipses from among the overlapping ellipses is shown in FIG. 13(d).

By sampling colors of an RGB image at the local maxima that are not removed, a result as shown in FIG. 13(e) may be obtained, and the sampled colors are combined with the ellipses so that 2D Gaussians are defined (see FIG. 13(f)).

In FIG. 13(f), geometric parameters of each ellipse may include a center position (u, v), an orientation, and a major axis (l₁), and a minor axis (l₂).

Lifting to a 3D space starts from back-projecting the center (u, v) into world-space coordinates by using a depth map D and a camera pose P provided by a tracking module. Defining a depth value d as D(u, v) and denoting a camera intrinsic matrix as K, dK⁻¹ (u, v, 1)^{T} represents a point in a camera coordinate system, which can be transformed into world-space coordinates by using P. In FIG. 12(a), (x, y, z) denotes world-space coordinates of the center.

Using the depth map D, a normal map N is generated, and the ellipse in the world coordinate system is rotated so as to be aligned with the surface ga n (see FIG. 14(b)). Next, as shown in FIG. 14(c), the major and minor axes are respectively scaled to

$${l}_{1}^{′} and {l}_{2}^{′} ,$$

so that the size of the ellipse projected in the world coordinate system becomes as close as possible to that of the original 2D ellipse. To construct a 3D Gaussian, a third axis along the normal direction is required; this is set to

$${l}_{2}^{′} ,$$

as illustrated in FIG. 14(d). Through this process, a 3D Gaussian is finally generated in the world coordinate system.

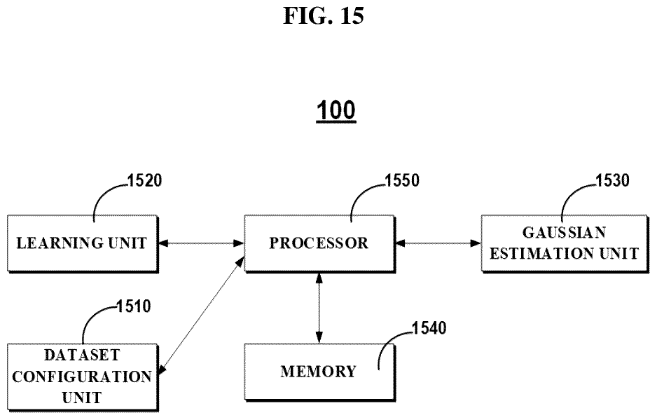

FIG. 15 is a block diagram schematically illustrating an internal configuration of a computing device according to an embodiment of the present invention.

Referring to FIG. 15, a computing device 100 according to an embodiment of the present invention includes a dataset configuration unit 1510, a learning unit 1520, a Gaussian estimation unit 1530, a memory 1540, and a processor 1550.

The dataset configuration unit 1510 randomly generates a Voronoi diagram for an input image and configures a dataset by using the Voronoi diagram. Since this has already been described with reference to FIG. 1, a duplicate description will be omitted.

The learning unit 1520 may train a deep learning-based Gaussian estimation model by using the dataset so that the deep learning-based Gaussian estimation model outputs a center probability map and a covariance map for an input image. Since this has already been described with reference to FIG. 1, a duplicate description will be omitted.

The Gaussian estimation unit 1530 inputs an input image to the trained deep learning-based Gaussian estimation model to generate a center probability map and a covariance map, and acquires 2D Gaussian parameters (a mean and a covariance) by post-processing the center probability map and the covariance map. This is also identical to what has been described with reference to FIG. 1, and thus a duplicate description will be omitted.

The memory 1540 stores various instructions for performing the deep learning-based adaptive Gaussian estimation method according to an embodiment of the present invention.

The processor 1550 is a means for controlling internal components according to an embodiment of the present invention (for example, the dataset configuration unit 1510, the learning unit 1520, the Gaussian estimation unit 1530, the memory 1540, etc.).

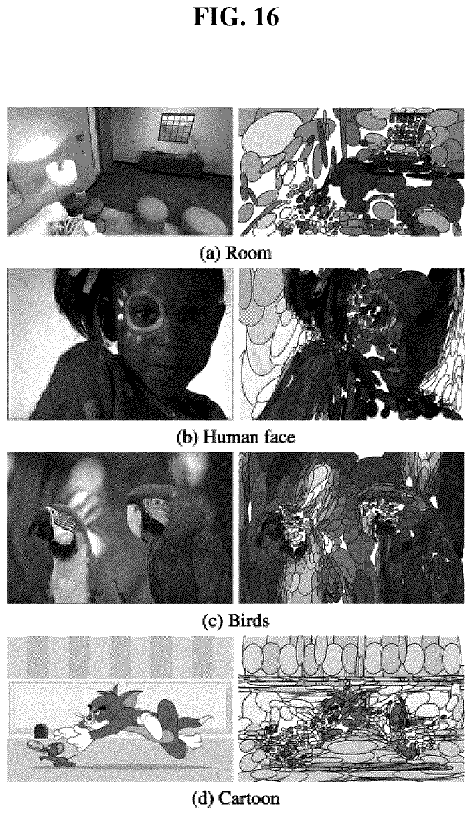

FIG. 16 is a view illustrating an example of extracting 2D Gaussians from general images according to an embodiment of the present invention. As shown in FIG. 16, it can be seen that 2D Gaussians can be extracted regardless of image style, such as persons, animals, structures (rooms), and cartoons.

The device and method according to the embodiments of the present disclosure may be implemented in a program that can be executed by various computers and may be recorded on computer-readable media. The computer-readable media may include program commands, data files, and data structures individually or in combinations thereof. The program commands that are recorded on a computer-readable media may be those specifically designed and configured for the present disclosure or may be those known to those engaged in the computer software field and thus available. The computer-readable recording media include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory. The program commands include not only machine language codes compiled by a compiler, but also high-level language code that can be executed by a computer using an interpreter, etc.

The hardware device may be configured to operate as one or more software modules to perform the operation of the present disclosure, and vice versa.

The present disclosure was described above focusing on the embodiments thereof. It would be understood by those skilled in the art that the present disclosure may be implemented in a modified form without departing from the scope of the present disclosure. Therefore, the disclosed embodiments should be considered in terms of explaining, not limiting. The scope of the present disclosure is shown in the claims, not in the above description, and all differences within an equivalent range should be construed as being included in the present disclosure.

What is claimed is:

1. A deep learning-based 2D Gaussian estimation method, comprising:
(a) randomly generating a Voronoi diagram and partitioning each region of the Voronoi diagram into a respective polygon;
(b) configuring a dataset by generating a gradient map, a center probability map, and a covariance map based on each of the partitioned polygons;
(c) training a deep learning-based Gaussian estimation model using the dataset so that the deep learning-based Gaussian estimation model is configured to output, for an input image, corresponding center probability and covariance maps; and
(d) inputting an image to the trained deep learning-based Gaussian estimation model to generate a center probability map and a covariance map, and deriving 2D Gaussian parameters including a mean and a covariance by post-processing the target center probability map and the target covariance map.

2. The method of claim 1, wherein step (a) comprises:
(a1) randomly generating seed points and generating a Voronoi diagram based on the seed points; and
(a2) randomly assigning colors to the respective regions of the Voronoi diagram.

3. The method of claim 2, wherein a number of seed points, a number of colors, and a distribution of polygons are randomly determined.

4. The method of claim 1, wherein generating the covariance map of the dataset comprises:
(b1) designating, as a center point, a target interior pixel of each polygon;
(b2) calculating a variance and a covariance by using the center point and coordinate values of boundary pixels of the polygon including the target interior pixel; and
(b3) generating a covariance matrix for the target interior pixel by using the calculated variance and covariance,
wherein steps (b1) to (b3) are repeatedly performed for all interior pixels of each polygon so as to generate the covariance map.

5. The method of claim 4, wherein the covariance map is expressed as any one of:
a first covariance map having a size of 2×2×H×W and including all elements of a 2×2 covariance matrix;
a second covariance map having a size of 3×H×W and obtained by reducing the 2×2 covariance matrix so as to include only three distinct elements of the 2×2 covariance matrix; and
a third covariance map having a size of 3×H×W and comprising components {a, b, c} of a lower triangular matrix obtained by applying Cholesky factorization to a 2×2 covariance matrix corresponding to each pixel constituting the covariance map so as to decompose the 2×2 covariance matrix into a product of the lower triangular matrix and a transpose matrix of the lower triangular matrix.

6. The method of claim 1, wherein the deep learning-based Gaussian estimation model comprises:
an encoder configured to receive the image and extract a feature map;
a first decoder configured to reconstruct the feature map to generate a gradient map;
a weight feature map generation module configured to generate a gradient weight feature map by scaling the gradient map to a size identical to that of the feature map and performing element-wise multiplication;
a second decoder configured to receive the gradient weight feature map and generate a center probability map; and
a third decoder configured to receive the gradient weight feature map and generate a covariance map.

7. A non-transitory computer-readable recording medium storing instructions that, when executed by a processor, cause the processor to perform the deep learning-based adaptive Gaussian estimation method according to claim 1.

8. A computing device comprising:
a dataset construction unit configured to randomly generate a Voronoi diagram and construct a dataset utilizing the Voronoi diagram;
a training unit configured to train a deep learning-based Gaussian estimation model to generate a Center Probability Map and a Covariance Map for an input image using the dataset; and
a Gaussian estimation unit configured to input an image into the trained deep learning-based Gaussian estimation model to generate a Center Probability Map and a Covariance Map, and obtain 2D Gaussian parameters including a mean and a covariance by post-processing the Center Probability Map and the Covariance Map.
